(19) United States
(12) Patent Application Publication
(10) Pub. No.: US 2012/0217197 A1
(43) Pub. Date: Aug. 30, 2012

(54) END OF WATER PURIFICATION CARTRIDGE LIFE APPARATUS

(75) Inventors: Michael A. Bridges, Seattle, WA (US); Alexander Lapidus, Bothell, WA (US); Marcus Alan Latham, Seattle, WA (US); James R. Scott, Bellevue, WA (US); Everett J. Nichols, Edmonds, WA (US); Jeffrey F. Williams, Langley, WA (US); Patricia Bottari, Seattle, WA (US)

(73) Assignee: HALOSOURCE, INC., Bothell, WA (US)

(21) Appl. No.: 13/407,600

(22) Filed: Feb. 28, 2012

Related U.S. Application Data
(60) Provisional application No. 61/447,481, filed on Feb. 28, 2011.

(51) Int. Cl. C02F 1/00; F17D 3/00; B01D 17/12

(52) U.S. Cl. 210/244; 210/251; 210/541; 137/2

(57) ABSTRACT

End-of-life apparatus for use in water purification cartridges are disclosed. The apparatus includes a water-disintegrable tablet configured to disintegrate a predetermined amount after contacting a predetermined volume of water flow. The tablet prevents the stoppage of water until the tablet has been contacted by the predetermined amount of water. The various end-of-life apparatus use different means to stop the water flow when the tablet has disintegrated a predetermined amount.

### CROSS-REFERENCE TO RELATED APPLICATION

This application claims the benefit of U.S. Provisional Application No. 61/447,481, filed on Feb. 28, 2011, incorporated herein in its entirety expressly by reference.

### BACKGROUND

Water purification systems may include a purification medium to remove unpleasant odors, tastes and color. Usually the purification medium has a predetermined capacity to absorb and/or remove water contaminants. When the capacity of the purification medium is reached, performance of the water purification system declines, and the user may notice this decline in performance through taste or smell. While unpleasant for the user, the user learns that the purification medium or the cartridge housing the medium needs replacing. In instances where the purification medium is relied upon to remove harmful pathogens, the user may not be able to rely on smell or taste as an indication of the end-of-life of the purification medium. In such cases, therefore, replacement can be performed on a predetermined schedule. Other means of determining exhaustion of the purification medium rely on counting the number of cycles the filter is used or integrating the total flow passing through the medium. While these methods may provide some safeguards that users won't drink pathogen-contaminated water, these systems nevertheless rely on human intervention to change out the purification medium. Either through forgetfulness or desire to save money, the purification medium may continue to be used even after its useful life has expired. Thus, exposing the user to the possibility of illness due to using water that has not been properly treated because the exceeding capacity of the purification medium is exceeded.

Accordingly, it would be useful to provide an apparatus that can prevent the use of a water purification cartridge when the purification medium has reached its capacity to remove or otherwise destroy pathogens.

### SUMMARY

A water purification cartridge includes a cap having one or more inlet holes; a cartridge body connected to the cap, wherein the cartridge body has one or more outlet holes; and an end-of-life apparatus within the water purification cartridge, wherein the end-of-life apparatus includes: a carrier mounted to the underside of the cap; a keeper connected to the carrier, wherein the carrier and keeper are in a fixed relationship to each other; a compressed spring between the keeper and carrier; and a plunger subjected to a force from the spring, wherein the plunger is in alignment with the inlet holes.

The water purification cartridge may further include a water-disintegrable tablet placed between the plunger and carrier, wherein the tablet prevents the plunger from sealing the one or more inlet holes in the cap.

The water-disintegrable tablet may be a water-soluble tablet, a water-erodible tablet, or a combination.

The water-disintegrable tablet may include at least one of a nutrient, phosphate scavenger, flavoring, halogen-releasing material, reducing agent, and masking agent.

The water purification cartridge may include a keeper having two opposed appendages, each appendage supports a post, each post terminating in a barb that is engaged with the carrier.

The water purification cartridge may include a rail on an inner surface of each post, wherein the rails are engaged with guides on the plunger.

The water purification cartridge may include a plunger comprising two appendages extending outward from a center, and a plug is located on the upper surface of each appendage.

The water purification cartridge may include a plunger comprising a pedestal on a center thereof, wherein a water-disintegrable tablet rests on the pedestal.

The water purification cartridge may include a carrier that includes at least one cowl on the underside thereof, a water-disintegrable tablet is located within the cowl and, an opening is created by the at least one cowl.

An end-of-life apparatus, may include: a carrier comprising a flat plate and at least one cowl on a side of the plate; a keeper connected to the carrier, the keeper comprises a flat base parallel with the carrier, wherein the carrier and keeper are in a fixed relationship to each other; a compressed spring between the keeper and carrier; and a plunger configured to be supported on rails connecting the carrier to the keeper, and the plunger compresses the spring against the keeper.

The end-of-life apparatus may include a water-disintegrable tablet placed between the plunger and carrier.

The water-disintegrable tablet may be a water-soluble tablet, a water-erodible tablet, or a combination.

The water-disintegrable tablet may include at least one of a nutrient, phosphate scavenger, flavoring, halogen-releasing material, reducing agent, or masking agent.

The end-of-life apparatus may include a keeper having two opposed appendages, each appendage supports a post, each post terminating in a barb that is engaged with the carrier.

The end-of-life apparatus may include a rail on an inner surface of each post, wherein the rails are engaged with guides on the plunger.

The end-of-life apparatus may include a plunger comprising two appendages extending outward from a center, and a plug is located on the surface of each appendage facing the carrier.

The end-of-life apparatus may include a plunger comprising a pedestal on a center thereof, wherein a water-disintegrable tablet rests on the pedestal.

The end-of-life apparatus may include a carrier that includes at least one cowl on the underside thereof, a water-disintegrable tablet is located within the cowl and, an opening is created by the at least one cowl.

A method for shutting off water flow to a water purification cartridge after a predetermined volume of water flow, including: providing an end-of-life apparatus in the cartridge, wherein the apparatus comprises a water-disintegrable tablet configured to disintegrate a predetermined amount after contacting the predetermined volume of water flow, wherein the tablet supports a plunger from closing an inlet hole in the cartridge; disintegrating the tablet through contact with water; and closing or substantially closing the inlet hole to the water purification cartridge with the plunger when the tablet disintegrates the predetermined amount.

The method may include forcing the plunger upward against the inlet hole with a compressed spring.

The method may include dissolving the tablet, eroding the tablet, or a combination.

The method may include releasing from the water-disintegrable tablet at least one of a nutrient, phosphate scavenger, flavoring, halogen-releasing material, reducing agent, or masking agent.

A water purification cartridge, includes: a cartridge body connected to a top cover and a bottom base, the cartridge body defining a hollow volume therein with a cross-sectional area; a cup-shaped tray within the hollow volume, wherein a size of a tray area substantially fills the cross-sectional area of the hollow, and the cup-shaped tray is configured to retain a predetermined volume of water; a water-disintegrable tablet between the tray and the base, wherein the tray is prevented from descending by resting on the tablet.

The water purification cartridge may include a shield on the base, the shield comprises a side wall and, the side wall surrounds the tablet.

The shield side wall may have one or more side openings.

The tray may be comprised of a material denser than water.

The water purification cartridge may include a spring pushing against the tray from a top side thereof.

The water-disintegrable tablet may include at least one of a nutrient, phosphate scavenger, flavoring, halogen-releasing material, reducing agent, or masking agent.

The water purification cartridge may include a hollow stand pipe in the tray, wherein the stand pipe height is lower than a rim of the tray, and the height of the stand pipe determines the volume of water retained in the tray.

The water purification cartridge may include at least one inlet hole in the top cap, at least one outlet hole in the base, and the tray underside comprises at least one plug aligned with the at least one hole in the base.

The tray may include one or more guides to guide the tray when descending.

A method for shutting off or substantially shutting off water flow from a water purification cartridge after a predetermined volume of water flow, includes: providing an end-of-life apparatus in the cartridge, wherein the apparatus comprises a water-disintegrable tablet configured to disintegrate a predetermined amount after contacting the predetermined volume of water flow, wherein the tablet supports a cup-shaped tray from closing an outlet in the cartridge; allowing water to flow from an inlet in the top of the cartridge to the cup-shaped tray, wherein a volume of water collects in the cup-shaped tray; allowing water to exit the cup-shaped tray, wherein the tray is weighted down by the volume of water collected in the tray; disintegrating the tablet through contact with water exiting the tray; and closing or substantially closing the outlet from the water purification cartridge with the weighted-down tray when the tablet disintegrates the predetermined amount.

The method may include placing the tablet in a shield on a base of the tray.

The method may include assisting the tray to close the outlet by placing a compressed spring to push on the tray.

The method may include releasing from the water-disintegrable tablet at least one of a nutrient, phosphate scavenger, flavoring, halogen-releasing material, reducing agent, or masking agent.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a water purification cartridge with an end-of-life apparatus within a water purification system;

FIG. 2 is a diagrammatical illustration of an exploded view of the water purification system of FIG. 1;

FIG. 3 is a diagrammatical illustration of a water purification cartridge with an end-of-life apparatus;

FIG. 4 is a diagrammatical illustration of an exploded view of one embodiment of a water purification cartridge with an end-of-life apparatus;

FIG. 5 is a diagrammatical illustration of an exploded view of one embodiment of a water purification cartridge with an end-of-life apparatus;

FIG. 6 is a diagrammatical illustration of an exploded view of one embodiment of a water purification cartridge with an end-of-life apparatus using a spring;

FIG. 7 is a diagrammatical illustration of an exploded view of one embodiment of a water purification cartridge with an end-of-life apparatus using a spring;

FIG. 8 is a diagrammatical illustration of an exploded view of one embodiment of a water purification cartridge with an end-of-life apparatus using a weight;

FIG. 9 is a diagrammatical illustration of an exploded view of one embodiment of a water purification cartridge with an end-of-life apparatus using a weight;

FIG. 10 is a diagrammatical illustration of an exploded view of one embodiment of a water purification cartridge with an end-of-life apparatus using a spring;

FIG. 11 is a diagrammatical illustration of an exploded view of one embodiment of a water purification cartridge with an end-of-life apparatus using a spring;

FIG. 12 is a diagrammatical illustration of a perspective view of a water purification cartridge with an end-of-life apparatus;

FIG. 13 is a diagrammatical illustration of an exploded view of the water purification cartridge of FIG. 10;

FIG. 14 is a diagrammatical illustration of an exploded view of the water purification cartridge of FIG. 10;

FIG. 15A is a diagrammatical illustration of a first embodiment of a tablet standoff used in the water purification cartridge of FIG. 10;

FIG. 15B is a diagrammatical illustration of a second embodiment of a tablet standoff used in the water purification cartridge of FIG. 10;

FIG. 16 is a diagrammatical illustration of an exploded view of a water purification cartridge with an end-of-life apparatus using a spring;

FIG. 17 is a diagrammatical illustration of an exploded view of a water purification cartridge with an end-of-life apparatus using a spring;

FIG. 18A is a diagrammatical illustration of a cross-sectional view of the end-of-life apparatus used in the water purification cartridge of FIGS. 16 and 17; and

FIG. 18B is a diagrammatical illustration of a cross-sectional view of the end-of-life apparatus used in the water purification cartridge of FIGS. 16 and 17.

### DETAILED DESCRIPTION

Disclosed herein is an end-of-life apparatus. An end-of-life apparatus disclosed herein may be used, for example, in a water purification cartridge containing a water purification medium that has a useful life beyond which the purification medium may not be able to remove and/or destroy microorganisms that may be harmful if ingested. A useful life of the purification medium may be measured by the volume of water that flows through the cartridge. It is advantageous to know when the useful life has been reached to shut off, close or slow down water flow to prevent the possibility that any harmful microorganism will have survived through the purification medium. Disclosed herein is an end-of-life apparatus that can shut off, close off, or slow down water flow from a water purification cartridge after an approximate predetermined volume of water has passed through the cartridge. End-of-life apparatus may include a water-disintegrable tablet, and means to close an inlet or outlet in the cartridge. Such means may include force-producing elements, such as springs, and weights. The force-producing element acts on a plunger or cup-shaped tray provided with plugs, wherein the water-disintegrable tablet supports the plunger or cup-shaped tray and prevents the closing of the inlet or outlet in the cartridge, until the predetermined volume of water has passed through the end-of-life apparatus thus reducing the size of the tablet and allowing the plunger or cup-shaped tray to close or substantially close the inlet or outlet of the cartridge.

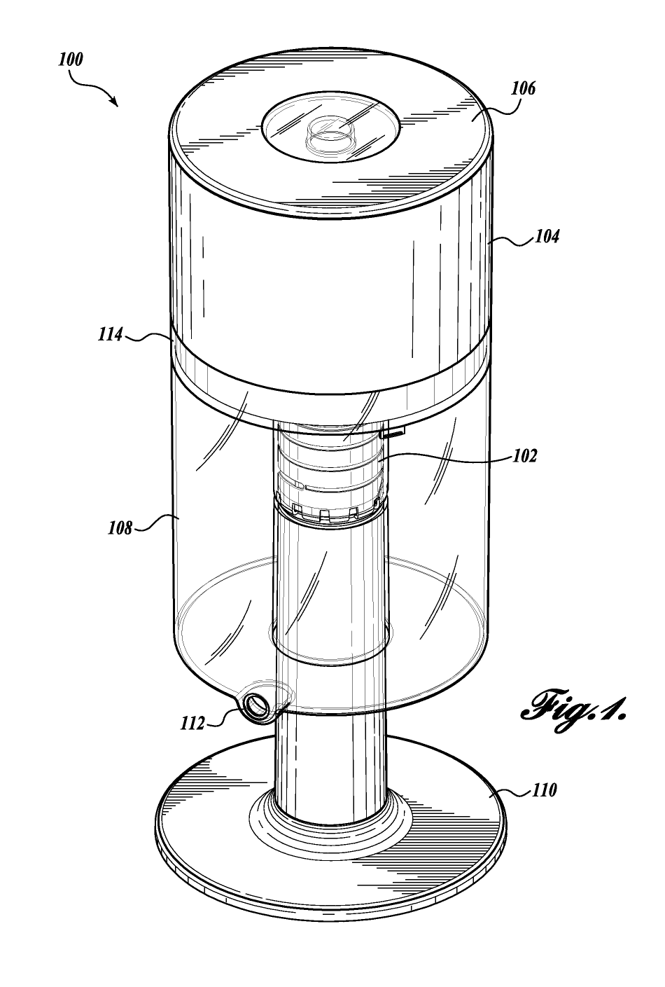

Referring to FIG. 1, a water purification system 100 is illustrated showing a water purification cartridge 102 with an end-of-life apparatus. The water purification system 100 is illustrated for purposes of showing the environment of the water purification cartridge 102 with the end-of-life apparatus. An end-of-life apparatus provides for the stoppage or significant slowing of water flow from a water purification cartridge, such as water purification cartridge 102 to alert the consumer that some action is required.

The water purification system 100 includes a top vessel 104 for placement of unpurified water. The top vessel 104 may be covered with cover 106. The bottom of the top vessel 104 connects to a spacer 114. The spacer 114 serves as the base of the top vessel 104 and is further used to house the water purification cartridge 102. The spacer 114 rests atop a bottom vessel 108. The bottom vessel 108 collects the purified water after passing through the water purification cartridge 102. The bottom vessel 108 includes an outlet 112 for dispensing the purified water. The water purification system 100 can be supported by a stand 110.

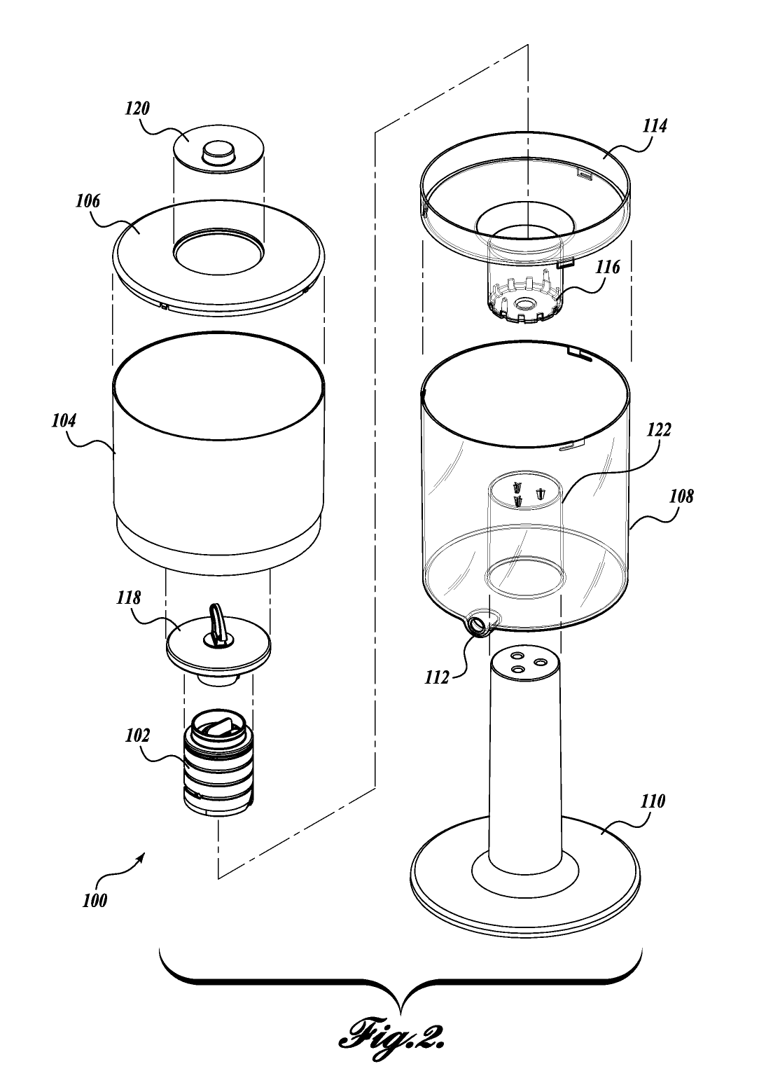

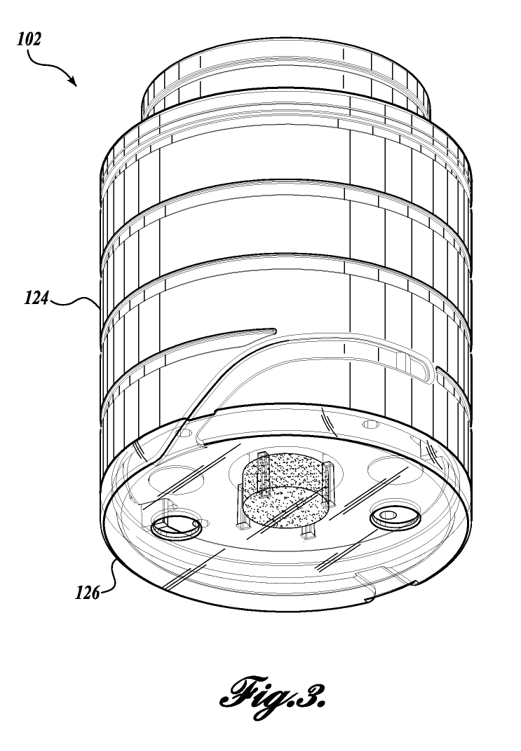

Referring to FIG. 2, the water purification system 100 components of FIG. 1 are shown more clearly. The top cover 106 may further include a viewing window 120. The viewing window 120 can be removable from the top cover 106. The water purification cartridge 102 fits within the cartridge holder 116 formed as a cup-shaped depression in the central portion of the spacer 114. As shown, the spacer 114 has an inverted frustoconically shaped floor to funnel the water to the water purification cartridge 102. In addition to the water purification cartridge 102, the water purification system 100 may also include a mechanical and/or adsorptive media prefilter 118. Prefilter 118 can be a coarse filter, such as a mesh or screen, or ceramic to remove particulate matter. Prefilter 118 may also include activated charcoal or carbon and the like to remove any unpleasant odor, taste and color from the water. In one embodiment, the bottom vessel 108 includes a stand support 122. The stand support 122 is a hollow tube projecting upward from the base of the bottom vessel 108. The top of the stand support 122 is closed. The top of the stand support 112 may have means, such as screws, or posts to connect the bottom vessel 108 to the stand 110. It should be appreciated that while one embodiment of a water purification system has been described, the water purification cartridge 102 with an end-of-life apparatus can be used in any water purification system. Furthermore, the water purification cartridge 102 of FIG. 3 may use one of the various embodiments of an end-of-life apparatus described below.

The water purification cartridge 102 has a cartridge body 124 connected to a cartridge base 126. The cartridge base 126 may be transparent. The top of the body 124 may be of a smaller diameter. The cartridge body 124 has interior structure described below for holding a purification medium.

While specific types of purification media may be described below, the type of purification medium is not meant to be limiting.

In one embodiment, the purification medium referred to herein can include any of the compounds known as N-halamines disclosed in any of U.S. Pat. Nos. 5,490,983; 5,670,646; 5,889,130; 6,020,491; 6,294,185; 6,548,054; 7,441,665; and U.S. Patent Application Publication No. 2008/0202992. All patents and applications are expressly incorporated by reference. These N-halamines have cyclic groups comprised of 4- to 7-membered rings. At least three members of the ring are carbon, up to two of which may form a carbonyl group. One to three members of the ring are nitrogen heteroatom, and the ring may also contain one oxygen heteroatom. Representative N-halamine groups include, but are not limited to halogenated hydantoins, oxazolidinones, and imidazolidinones. N-halamine precursors are the non-halogenated versions of the N-halamines.

N-halamine and precursor groups can be incorporated into polymers by functionalizing the group with a polymerizable moiety such as a vinyl group. (A precursor refers to the amine group without halogen.) Alternatively, a polymer, such as polystyrene, can be modified to introduce the N-halamine or precursor groups on the polymer. N-halamines provide purification when microorganisms become inactivated after coming into contact with halogen atoms bound to the nitrogen atoms of the cyclic amines. The halogen can include chlorine, bromine, or both. The purification medium may be a loose powder, as described in U.S. Pat. No. 5,490,983, but preferably it is in the form of larger particles, such as the beads described in U.S. Pat. Nos. 6,548,054 and 7,687,072.

Representative purification media includes, but is not limited to, compounds selected from a heterocyclic N-halo amine, an N-halo hydantoin, a polystyrene having pendent N-halo hydantoin groups, or a crosslinked polystyrene having pendent N-halo hydantoin groups. Representative chemical formulae of the purification media include, but are not limited to the following structures:

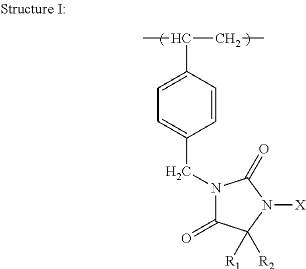

R₁ and R₂ are independently selected from C₁-C₄ alkyl, phenyl, and aryl, and X must be chlorine or bromine for the polymer to be biocidal.

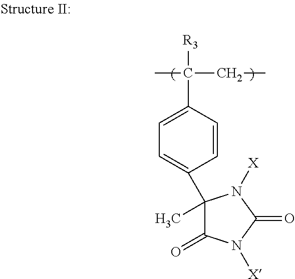

X and X′ are independently chlorine, bromine, or hydrogen. At least one of X or X′ must be chlorine or bromine for the polymer to be biocidal. R₃ is hydrogen or methyl.

The polystyrene polymer of either Structure I or Structure II may be crosslinked using an agent, such as divinylbenzene, to form a particle of a size range large enough to allow for retention on a porous barrier material. The crosslinking agent can be present in an amount from approximately 3% to 10% by weight of the total weight of the chosen polymer (Structure I or Structure II). One form of the purification medium is a 3% to 10% crosslinked Structure I or II, where X is bromine in Structure I, or one or both of X and X′ is bromine in Structure II.

While N-halamines are known to be rechargeable through continuous contact with chlorine and/or bromine, which extends the useful life almost indefinitely, in other embodiments, it may be preferable not to undergo this continuous maintenance and replace the cartridge or the purification media when the useful life is at an end.

For this purpose, the end-of-life apparatus can be provided in the water purification cartridge 102.

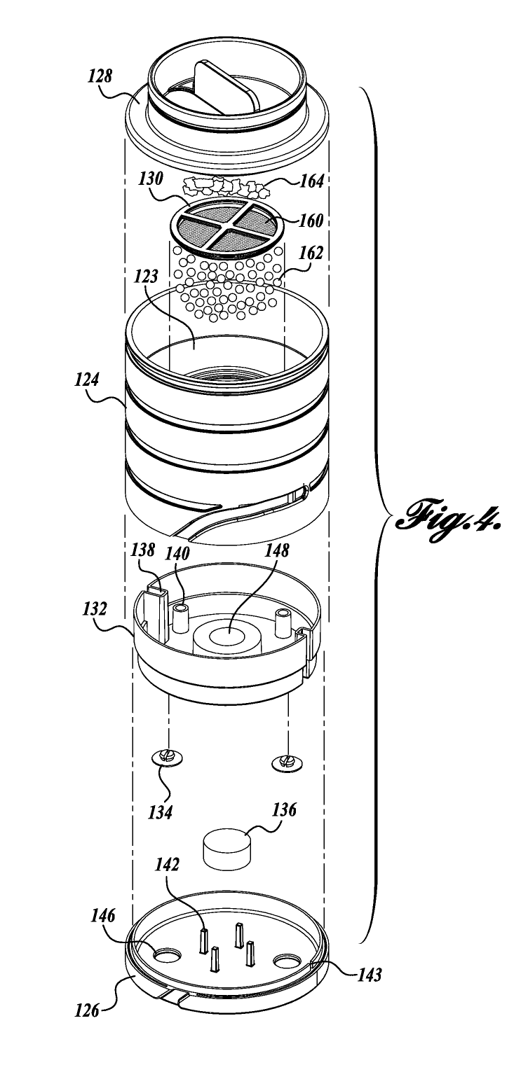

Referring to FIG. 4, the components of one embodiment of the water purification cartridge 102 illustrated in FIG. 3 are shown more clearly.

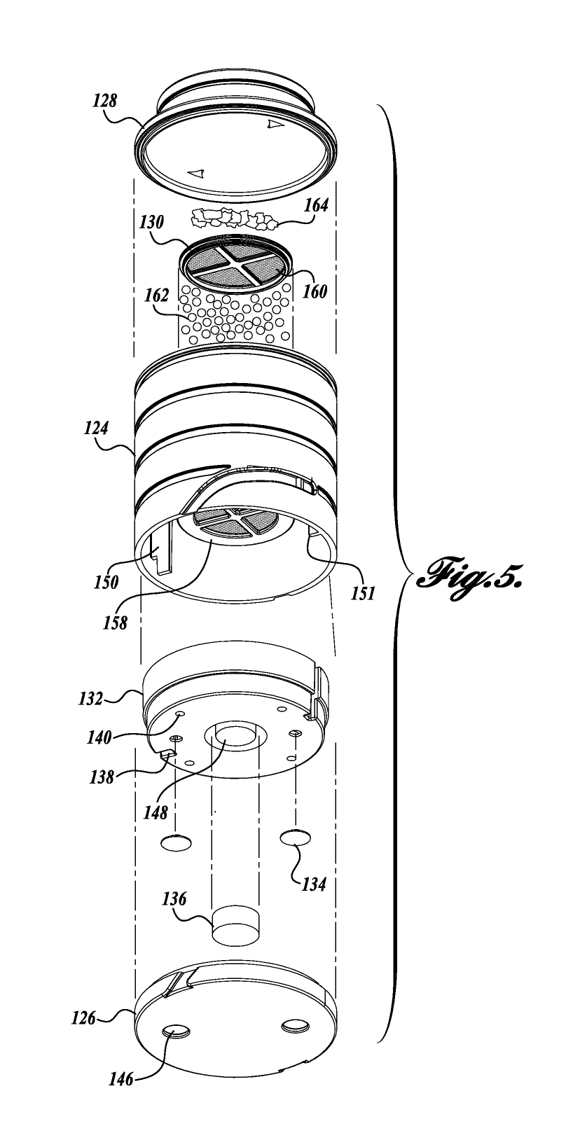

The water purification cartridge 102 includes a cartridge top cover 128. The cartridge top cover 128 includes inlet holes for allowing water to enter the water purification cartridge 102. The cartridge top cover 128 rests on the top rim of the cartridge body 124. The cartridge body 124 includes a funnel-shaped shelf 123 leading into an interior compartment. A screen mesh 160 supported on a frame 130 is placed at the bottom of the funnel-shaped shelf 123. A compartment between the top cover 128 and the screen mesh 160 can be provided with a filter medium, such as granulated activated carbon 164. The funnel-shaped shelf 123 leads into an interior compartment that holds the desired purification medium 162. The interior compartment is fitted on top with the permeable screen 160 on a frame 130 and, likewise, with a permeable screen 158 at the bottom (seen in FIG. 5). The screens allow the purification medium 162 to be contained within the interior compartment.

A cup-shaped tray 132 fits inside and within the cartridge body 124. Below the shelf 123, the cartridge body 124 includes an annular space formed between the interior wall of the body 124 and the exterior wall of the interior compartment. The tray 132 fits within this annular space. The cup-shaped tray 132 is within a hollow volume, wherein the size of the tray 132 area substantially fills the cross-sectional area of the hollow, and the cup-shaped tray 132 is configured to retain a predetermined volume of water. The tray 132 can descend from a first elevation to a lower elevation in the body 124. The tray 132 is assisted in descending by application of a force, such as via a spring, weight, or a combination. The tray 132 may be a bright distinctive color, such as yellow or red, that can be clearly noticed when the tray 132 has descended by viewing through the base 126. In one embodiment, the cartridge base 126 can be transparent and made from clear plastic, for example. A transparent base 126 can allow viewing when the tray 132 has descended.

The tray 132 is cup-shaped to allow water to collect within the tray 132. In the embodiment of FIGS. 4 and 5, the tray 132 may be made from a dense material, which is denser than water. The tray 132 includes a base with one or more stand pipes 140 projecting vertically upwards from the base. The height of the one or more stand pipes 140 is lower than the upper rim of the tray 132. The stand pipes 140 are passages that allow water to rise in the tray 132 below the upper rim of the tray 132 and to the level of the stand pipes 140. The water flows from the stand pipes 140 to the base 126 and eventually to the outlets 146 of the base 126. In one embodiment, the outlet 146 from the base 126 can correspond with the outlet from the water purification cartridge 102. The tray 132 includes a pedestal structure 148 as best seen in FIG. 5. The pedestal 148 projects from the lower side of the tray 132 and rests on a water-disintegrable tablet 136. The pedestal 148 may also serve as a feature to allow for the addition of a means to provide additional force for shutting off flow (e.g., spring or weights). The tray 132 may include one or more sleeves 138 formed as inwardly projecting indentations in the outer wall of the tray 132. One sleeve may be constructed deeper (in the radial direction) to serve to align the parts correctly when assembling. Sleeves 138 may engage with vertically disposed guide rails on the inside of the cartridge body 124. One rail may extend more in a radial direction to be capable of only receiving the correct sized sleeve. The purpose of the one or more sleeves 138 and guide rails are to maintain the tray 132 in a straight position to allow the tray 132 to descend smoothly without binding or catching on a side of the body 124. Finally, the tray 132 includes one or more plugs 134. Plugs 134 are made from a pliable material and project below the bottom surface of the tray 132. The purpose of the plugs 134 is to seal the outlets 146 in the base 126 when the tray 132 descends. The water purification cartridge 102 includes the cartridge base 126. The upper rim of the base 126 includes an alignment notch 143 which allows the base 126 to fit in a predetermined position on the body 124. Specifically, the notch 143 engages the rail 151 (best seen in FIG. 5), while the diametrically opposed rail 150 has a cutout to permit the upper rim of the base 126 to fit therein.

The cartridge base 126 includes one or more outlet holes 146. The outlet holes 146 are aligned directly underneath the plugs 134. When the tray 132 descends, the plugs 134 will align with the outlet holes 146 and prevent or at least lessen the flow of water from leaving the base 126 and cartridge 102. The cartridge base 126 includes means to hold a tablet 136. In the embodiment illustrated, a plurality of posts 142 are used to hold the tablet 136 from lateral movement.

Referring to FIG. 5, the annular space in the cartridge body 124 within which the tray 132 fits is clearly visible. The guide rail 150 that engages with the sleeve 138 is also visible. In the illustrated embodiment, two guide rails 150 and 151 are placed opposite to each other inside of the body 124. Each guide rail will have a corresponding sleeve on the tray 132. One of the guide rails and sleeve and can be made wider than the other, which permits only one manner of fitting the tray 132 inside the body 124, thus, ensuring a correct alignment. Also worth noting is the pedestal 148 surrounded by an annular space. The pedestal 148 rests on the tablet 136 to maintain the tray 132 in the elevated position. The water-disintegrable tablet 136 rests between the tray 132 and the base 126, wherein the tray 132 is prevented from descending by resting on the tablet 136. When the tray 132 descends to a lower position, the tray 132 is unimpeded by allowing the posts 142 to fit within the annular space surrounding the pedestal 148.

Unpurified water will pass through a purification medium 162 housed in the cartridge body 124 within an interior compartment of the cartridge body 124 to become purified water. From the outlet of the interior compartment, the purified water then passes out of the cartridge through the outlets 146 provided in the floor of the cartridge base 126. In the elevated, the tray 132 maintains the plugs 134 above the outlets 146, thus allowing water to flow out of the base 126 and water purification cartridge 102. The floor of the cartridge base 126 supports a water-disintegrable tablet 136. In turn, the tray 132 applies a pressure on the topside of the tablet 136.

The purification medium 162 has a predetermined useful life. For example, the useful life of the purification medium 162 may be measured as a volume of water. In one embodiment, the useful life may be determined to be 600 liters. With a predetermined volume of water known, a combination of factors may be designed such that after flowing 600 liters, the tablet 136 will have disintegrated sufficiently to allow the tray 132 to descend such that the plugs 134 will block the outlet holes 146.

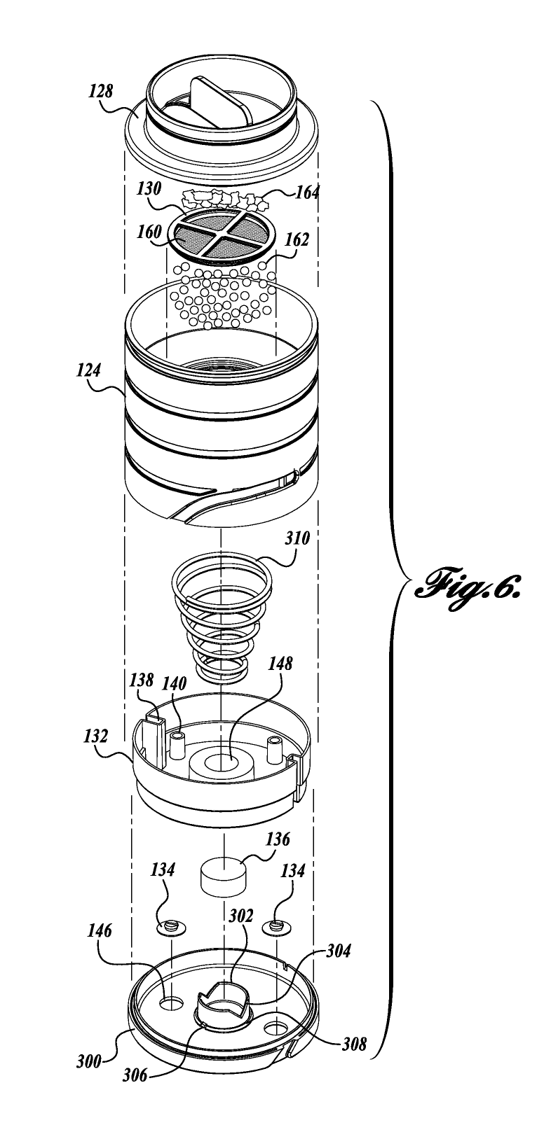

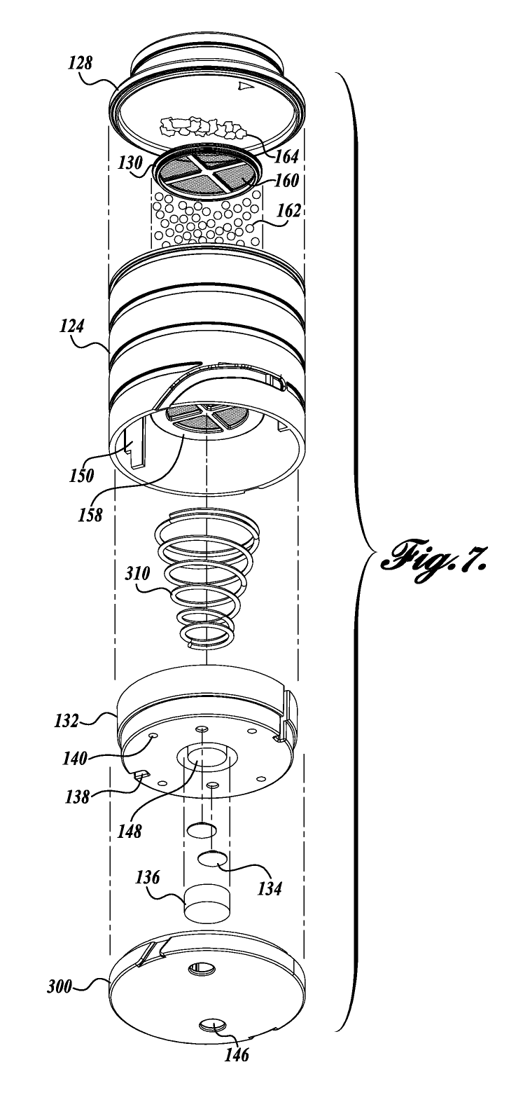

Referring to FIGS. 6 and 7, a second embodiment of an end-of-life apparatus for the water purification cartridge 102 is illustrated. The water purification cartridge of FIGS. 6 and 7 is in many respects similar to the embodiment of FIGS. 4, and 5, except as described below. Like numbers in FIGS. 6, and 7 represent like parts.

The water purification cartridge of FIGS. 6 and 7 uses a different base 300, compared to base 126 in FIGS. 4, and 5, and, the end-of-life apparatus uses a spring 310 to apply force on the tray 132 to assist in closing of the outlets 146.

The base 300 includes a shield 302 placed in the center at the bottom of the base 300. The shield 302 is a cylindrical sleeve with an open top and a closed bottom. The closed bottom prevents water intrusion from the bottom of the shield 302. In one embodiment, the height of the shield rises to and can be commensurate in height with the tablet 136. In other embodiments, the shield 302 can have a height that is less than or greater than the height of the tablet 136. The tablet 136 can fit within the shield 302. The shield 302 includes a bottom base to positively seal off water from intrusion from the bottom of the base. The base 300 includes a circular snap 308. The circular snap 308 includes a small notch 306, which serves as an alignment tool. The circular snap 308 includes a bump in the interior thereof to allow the bottom edge of the shield 302 to snap into the groove. For this purpose, the bottom perimeter of the shield 302 includes a corresponding groove to mate with the circular bump on the inside of the circular snap 308. The shield 302 includes a radially projecting tab 306 which fits into the notch provided in the circular snap 308. In one embodiment of the shield 302, “V” notches 304 are provided on diametrically opposed sides of the shield 302. The V notches describe an angle defined by the respective sides of the notch 304. The bottom of the V notches is raised with respect to the floor of the base 300. The bottom of the V notch may be at the level of the floor of the base 300. The top of the V notch may end at the top of the shield 302. In one embodiment, the angle defined by the sides of both notches 304 is about 76° to 100°. Embodiments of the notch 304 can be any angular degree within the foregoing range. In one embodiment, the shield 302 does not include any notches, and therefore, the shield 302 is a solid cylindrical body.

The V notches 304 permit a controlled exposure of the tablet 136 to water, and thus, the parameters of the V notches are designed to control the length of the life of the tablet 136. For example, the life of the tablet 136 may be extended or reduced by opening or closing the angle of the V notches 304. Alternatively and/or additionally, fewer V notches may be provided, or more V notches may be provided.

In addition to or in the alternative, straight notches, such as rectangular notches may be used instead of the V notches. The rectangular notches may extend from a height above the floor of the base 300 to the top of the shield 302.

In addition to or in the alternative, round or circular notches may be used. The round notches may extend from a height above the floor of the base 300 to the top of the shield.

While various illustrative notch shapes are described, any shape of notch may be suitable, including combinations of shapes.

Notches 304 can extend starting from the floor of the base 300, or starting from any height above the floor of the base 300.

Furthermore, the shape of the notches 304 allows a greater amount of water to contact the tablet 136 based on a rising level of water in the base 300. For example, the open area of the V notch 304 increases with respect to the height of the shield 302. Accordingly, when the water level backs up and increases the height in the base 300, more water is allowed through the V notches and contacts the tablet 136, and self-corrects for increased flow rates.

The embodiment of FIGS. 6-7 allows the tablet 136 to make direct contact with water when the water level rises above the lowermost open space in the V notch (or other open space), and the water floods inside the shield 302.

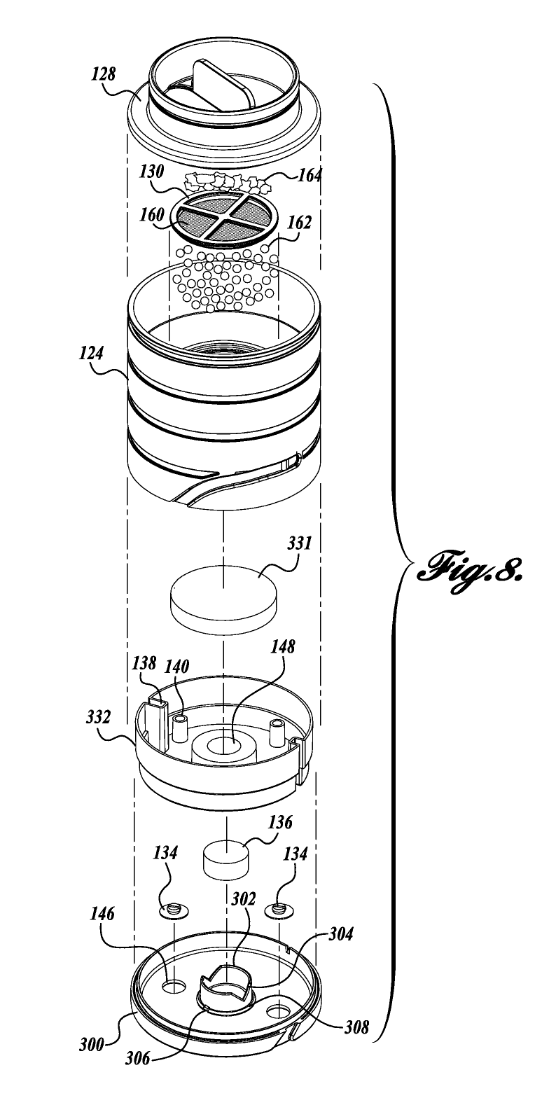

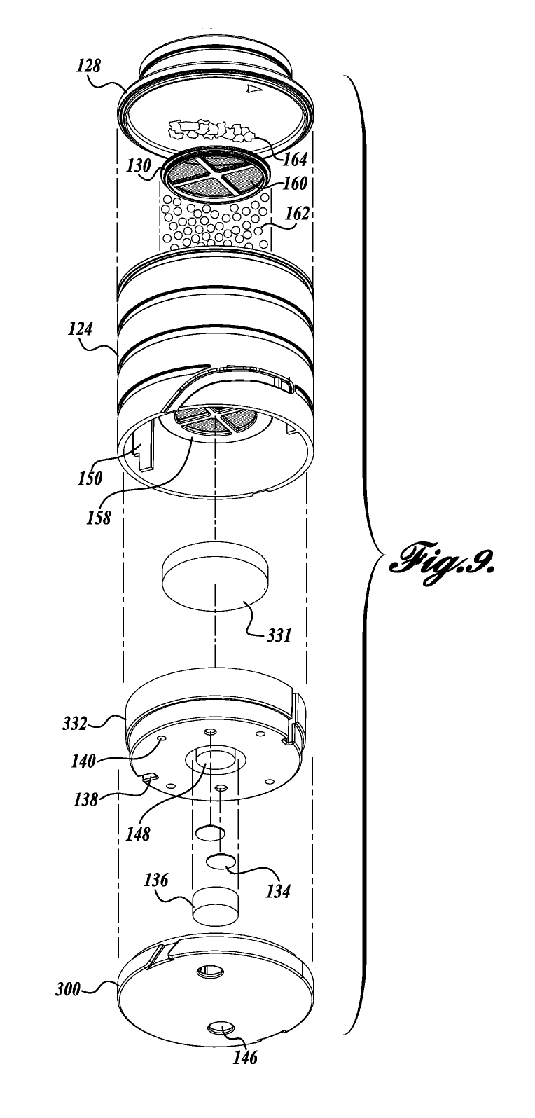

The spring 310 is juxtaposed between the top of the pedestal 148 and the bottom of the screen 158. The spring 310 applies a downward pressure on the tray 132 to more tightly seal the outlet holes 146 of the base 300 using the plugs 134. A similar spring may also be used in the embodiment shown in FIGS. 4, and 5. The spring 310, however, is optional. For example, the spring 310 can be omitted as shown in the third embodiment of FIGS. 8 and 9.

Referring to FIGS. 8 and 9, a third embodiment of an end-of-life apparatus for the water purification cartridge 102 is illustrated. The water purification cartridge of FIGS. 8 and 9 is in many respects similar to the embodiment of FIGS. 6, and 7, except as described below. Like numbers in FIGS. 8, and 9 represent like parts.

In the embodiment of FIGS. 8 and 9, the cup-shaped tray 332 can be made from a dense plastic (denser than water), and/or alternatively a weight 331 (such as metal) can be added on top of the tray 332, or weights may be incorporated into the tray 332 to apply greater downward force. The added weight may be incorporated, such as by placing the weights in and around the plastic tray 332. Alternatively, the tray 332 may be made from metal.

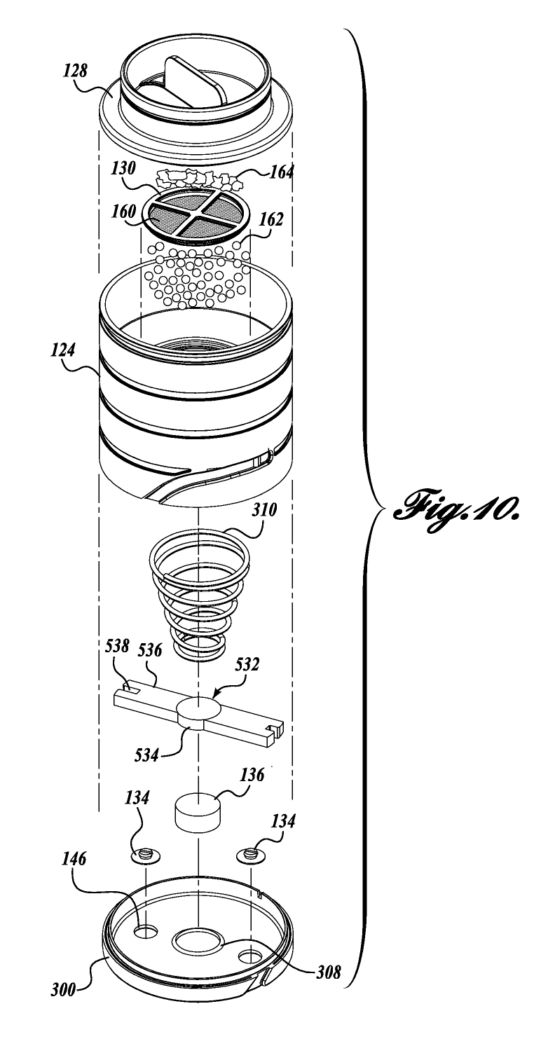

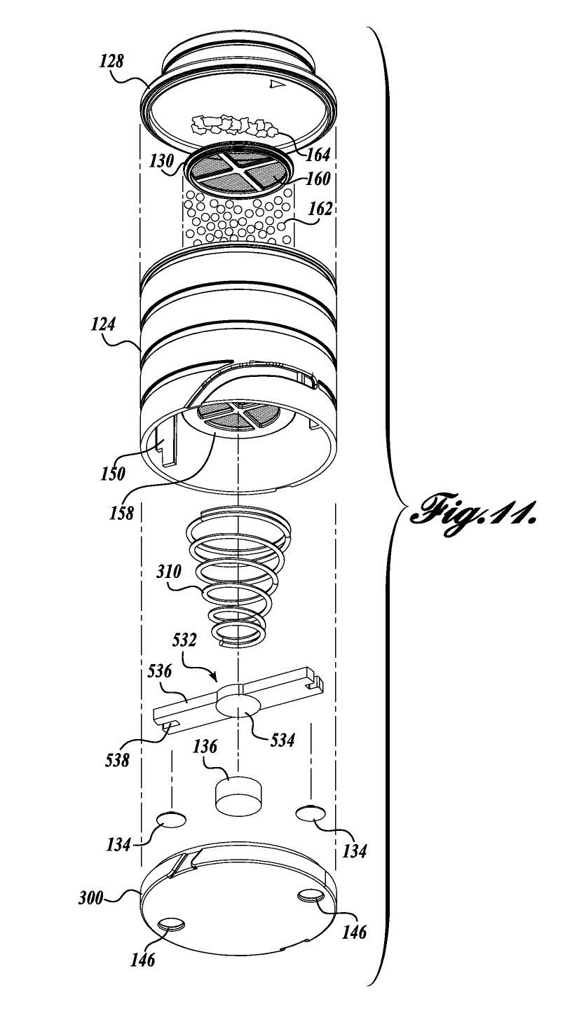

Referring to FIGS. 10 and 11, a fourth embodiment of an end-of-life apparatus for the water purification cartridge 102 is illustrated. The water purification cartridge of FIGS. 10 and 11 is in many respects similar to the water purification cartridge 102 of FIGS. 6 and 7, except as described below. Like numbers in FIGS. 10, and 11 represent like parts.

The embodiment of FIGS. 10 and 11 does not use a cup-shaped tray. Instead, the cup-shaped tray is replaced with a flat plunger 532. The plunger 532 includes a center, circular (or otherwise) section 534 that rests on the top side of the tablet 136. The plunger 532 includes radially extending, diametrically-opposed arms 536 that support the plugs 134 on the bottom side thereof. The ends of the arms 536 include notches 538. The notches 538 fit within the rails 150, and assist in guiding the plunger 534 as it descends. The spring 310 applies downward pressure on the plunger 532, which in turn applies pressure on the top surface of the tablet 136. The tablet 136 may be held in place on the base 300 by a circular ring 308, or a shallow depression may be formed in the base 300. Alternatively, the ring or depression may be provided on the underside of the plunger 532. In either case, there is no shield or other structure covering the walls of the tablet 136, such that the tablet 136 walls are totally exposed and, the tablet 136 top surface and bottom surface are compressed, respectively, between the plunger 532 and base 300. Disintegration of the tablet 136 can happen on the walls. The life of the tablet 136 can be extended by increasing the height of the tablet 136, and conversely, the life of the tablet 136 can be reduced by decreasing the height of the tablet 136. This allows different lifespans to be selected. The spring 310 can apply pressure directly on the plunger 532 in the center section 534 thereof, which in turn applies pressure on the tablet 136. As can be appreciated, the tablet 136 supports the plunger 532 with plugs 134 directly above the outlets 146, until the tablet 136 disintegrates sufficiently to permit the plunger 532 to descend so that the plugs 134 close the outlets 146.

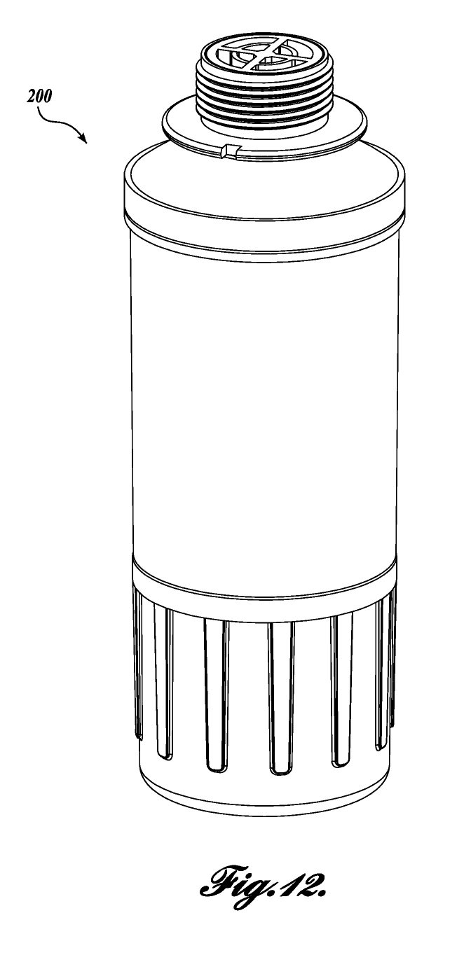

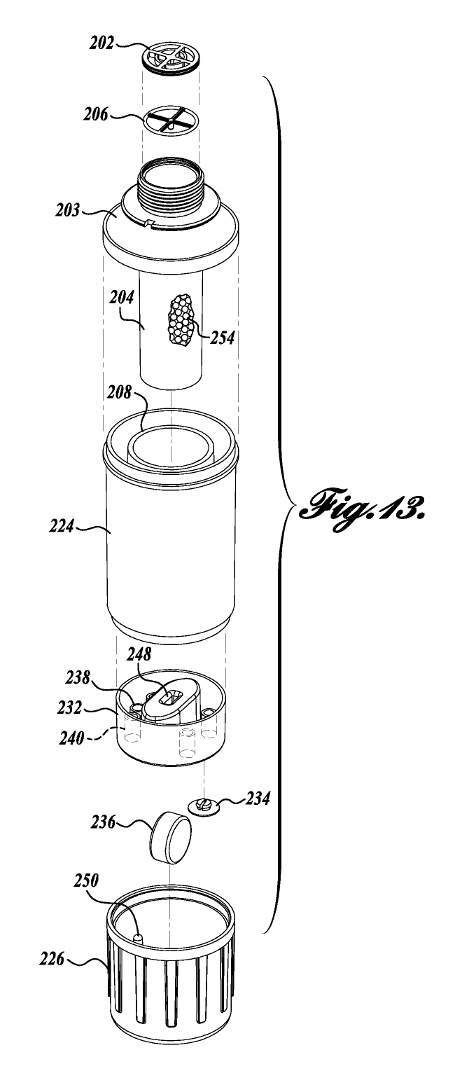

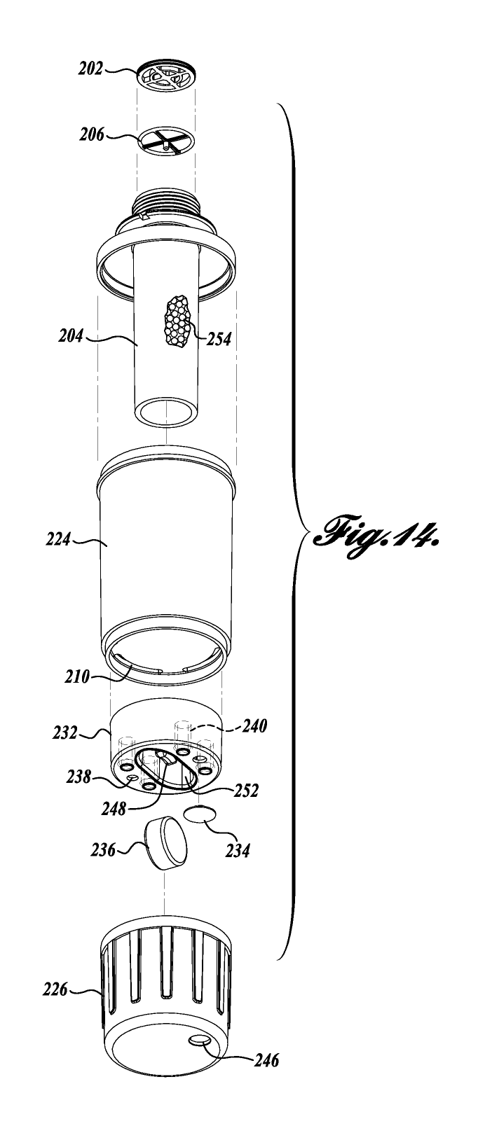

Referring to FIG. 12, a second embodiment of a water purification cartridge 200 is illustrated. In FIGS. 13 and 14, the components of the water purification cartridge 200 are more clearly visible. The water purification cartridge illustrated in FIG. 12 may be used, for example, in pitchers, or other point of use water sources. Similar to the other embodiments, the embodiment of FIG. 12 includes an end-of-life apparatus.

Referring to FIGS. 12A, and 12B, at the top inlet to the cartridge 200, the water purification cartridge 200 includes a permeable screen and frame 202 that closes a top end of an inner vessel 204. The inner vessel 204 holds the purification medium 254. The bottom of the inner vessel 204 is also closed with a permeable screen and frame 206. The water purification cartridge 200 can fit within an existing structure of a water purification system, such as a pitcher, to treat water. The cartridge 200 may be threaded onto such a device by the top screw threads provided. The inner vessel 204 has a hood 203 being of a larger diameter than the vessel itself. The water purification cartridge 200 includes a cartridge body 224. The cartridge body 224 is formed with an interior cup 208. The cup 208 is open on top, but sealed on the bottom. The inner vessel 204 fits within the cup 208 such that the bottom of the inner vessel 204 does not contact the floor of the cup 208. Further, the hood 203 of the inner vessel 204 is frustoconical in shape such that the outer edge of the hood rests on the upper peripheral edge of the cartridge body 224. However, the upper peripheral edge of the cup 208 is not in contact with and does not seal to the underside of the hood 203 of the inner vessel 204. Thus, as can be appreciated, once water exits from the inner vessel 204, the water rises in the annular space created between the inner vessel 204 and cup 208 and spills over the upper peripheral edge of the cup 208 into another annular space created between the wall of the body 224 and the wall of the cup 208.

As seen in FIG. 14, the cartridge body 224 has elongated curved weep holes 210 at the bottom thereof to drain the water from the annular space. The water purification cartridge 200 includes a cartridge base 226. The water purification cartridge 200 includes an end-of-life apparatus to shut off or reduce water flow from the cartridge when the purification medium 254 is exhausted. In the embodiment disclosed in FIGS. 13 and 14, the end-of-life apparatus includes a cup-shaped tray 232 to collect water. However, the tray 232 is assisted in descending by application of a downward force, such as through a spring, weights, or both. Additionally, the tray 232 may be made from a dense material that is denser than plastic. The cup-shaped tray 232 is within a hollow volume, wherein the size of the tray 232 area substantially fills the cross-sectional area of the hollow, and the cup-shaped tray 232 is configured to retain a predetermined volume of water. The tray 232 includes one or more stand pipes 240. The height of the upper periphery of the tray 232 is higher than the height of the stand pipes 240. The stand pipes 240 are hollow, thus allowing the water level to rise in the tray 232 to the height of the stand pipes 240, then overflow into the cartridge base 226. The tray 232 includes a downward pointing pedestal 248 formed on the underside thereof. The tray 232 is maintained in an elevated position in the base 226 when the pedestal 248 rests on a water-disintegrable tablet 236. The water-disintegrable tablet 236 is between the tray 232 and the base 226, wherein the tray 232 is prevented from descending by resting on the tablet 236. Additionally, the tray 232 includes a plug 234 used to seal an outlet 246 of the water purification cartridge 200 located in the cartridge base 226.

Referring to FIG. 14, the pedestal 248 is more clearly visible. The pedestal 248 is surrounded by a hollow space 252 that allows the tray 232 to descend without interfering with the structure holding the tablet 236, which is further described below.

The cartridge base 226 includes a guidepost 250 (seen in FIG. 13) projecting vertically from the floor of the base 226. The guidepost 250 fits within a guide sleeve 238 formed in the tray 232. The guidepost 250 and guide sleeve 238 cooperate to maintain a straight alignment when the tray 232 descends.

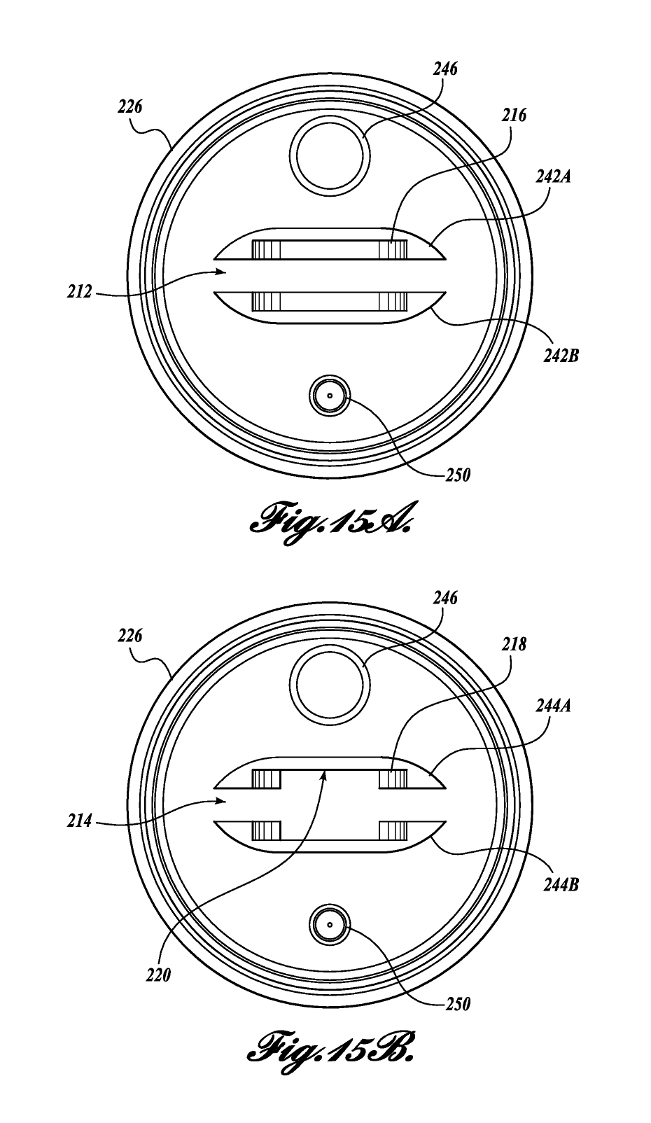

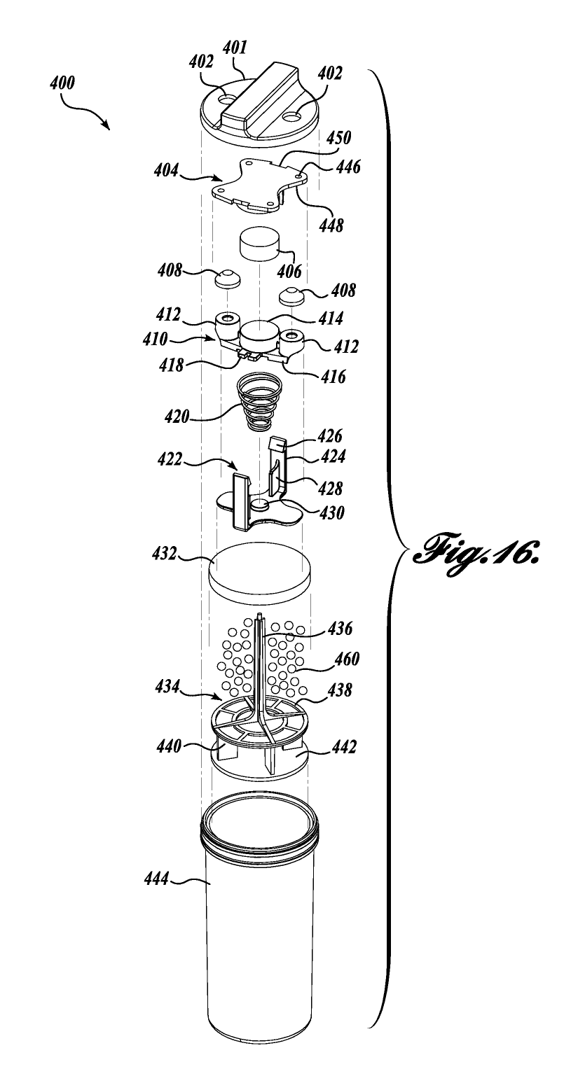

Referring to FIG. 15A, a top view of the cartridge base 226 is illustrated. Projecting upward from the floor of the base 226 are a first and second tablet standoff 242a and 242b, which are mirror images of each other. The tablet standoffs are separated by a slot 212, which is flush with the floor of the base 226. Each standoff 242a and 242b includes a shelf 216 for supporting the tablet 236 above the floor of the base 226. The slot 212 may be narrowed or widened depending on the amount of contact area desired between water and the tablet 236.

Referring to FIG. 15B, a second embodiment of a base 226 for the water purification cartridge 200 is illustrated. In the embodiment illustrated in FIG. 15B, a first and a second tablet standoff 244a and 244b are likewise placed on opposite sides of a slot 214, which is flush with the floor of the base 226. Similar to the embodiment of FIG. 15A, the standoffs 244a and 244b include a curved shelf 218 for supporting the tablet from contact with the floor of the base 226. In the embodiment of FIG. 15B, a portion of the shelf 218 is removed to provide more contact area 220 to allow even greater surface area contact between the water and the tablet 236.

The water that collects in the cartridge base 226 will contact the tablet 236 to cause disintegration. The water is allowed to flow out from the outlet hole 246. The purification medium 254 will have a predetermined volume of water that can be treated before the purification medium 254 is considered exhausted. With a predetermined volume of water known, a combination of factors may be designed into the tablet 236, such that the tablet 236 will disintegrate sufficiently when the predetermined volume of water has passed through the cartridge.

The tray 232 is supported in the elevated position when the pedestal 248 rests on top of the tablet 236. In this position, the plug 234 is elevated directly above the cartridge outlet 246. The base 226 includes a guidepost 250 and the tray 232 includes a guide sleeve 238 that cooperates with the guidepost 250 to maintain the tray 232 straight as it descends. Furthermore, the guidepost 250 and guide sleeve 238 also require assembling in a specific manner such that the plug 234 becomes directly aligned over the outlet 246. As the tablet 236 begins to disintegrate, the tray 232 applies a downward force. The tray 232 may be weighted down, either by being made from a dense (denser than water) material, or applying metal weights. Additionally, or alternatively, a spring may be used to apply a downward force on the tray 232.

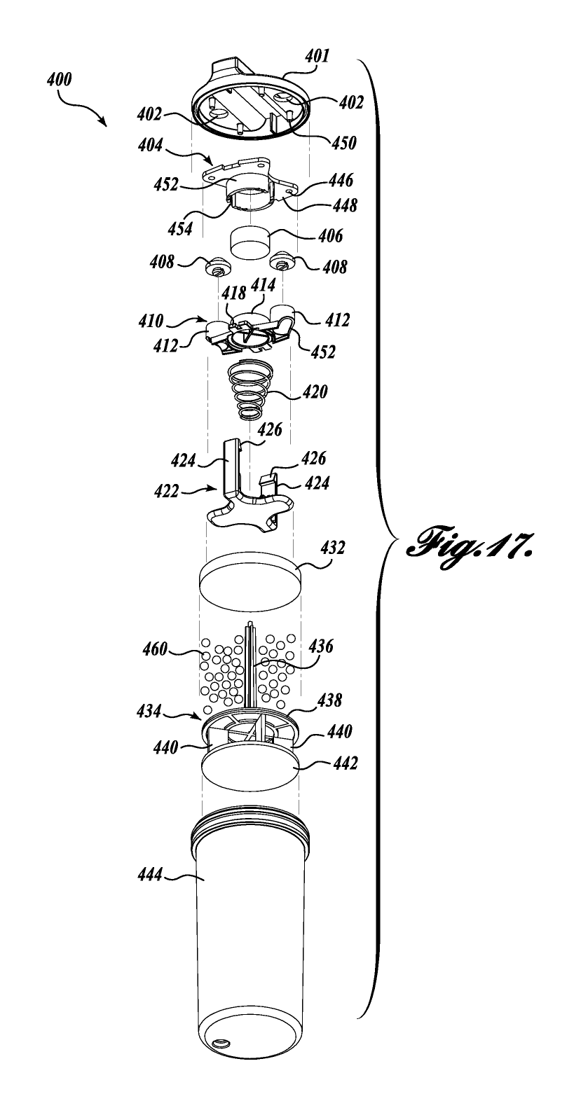

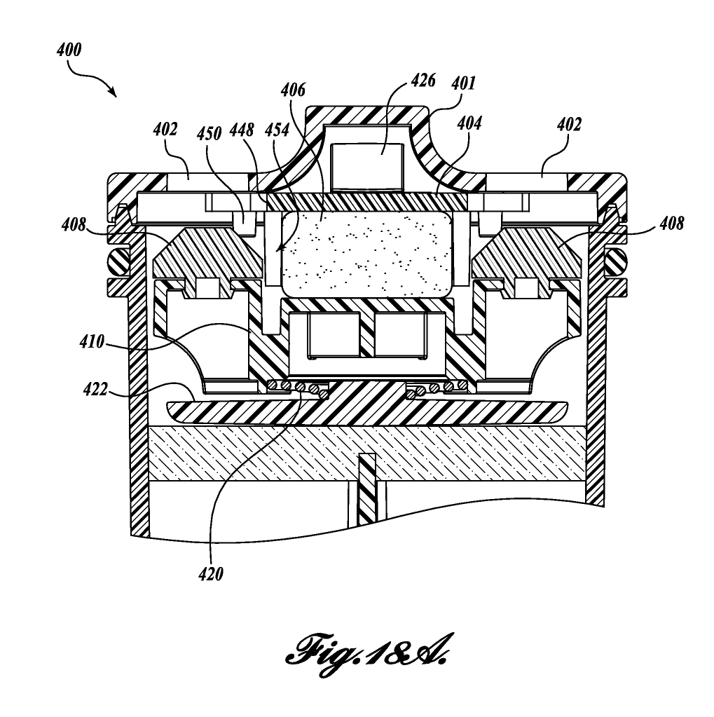

Referring to FIGS. 16 and 17, a water purification cartridge 400 with an end-of-life apparatus is illustrated. The water purification cartridge 400 illustrated in FIGS. 16-18 may be used, for example, in the system of FIG. 1, or alternatively in pitchers, or other point of use water sources. Similar to the other embodiments, the embodiment of FIGS. 16-18 includes an end-of-life apparatus. An advantage of the end-of-life apparatus of FIGS. 16-17 is the construction of the end-of-life apparatus as a unit, which unit can be readily incorporated into a number of different water cartridges. While one illustrative embodiment of a water purification cartridge is described, it is to be appreciated that the end-of-life apparatus is not thereby limited.

The water purification cartridge 400 includes a cap 401, and a cartridge body 444 defining a void therein into which the end-of-life apparatus fits. The end-of-life apparatus includes a carrier 404, a plunger 410 with plugs 408, a tablet pedestal 414, a spring 420, a keeper 422 for retaining the plunger 410 in alignment and, keeps the end-of-life apparatus as a unit. The end-of-life apparatus can be placed immediately below the cap. Additionally, the water purification cartridge 400 may include a non-woven mesh 432 below the end-of-life apparatus, a spacer 434 comprising a support post 436 connected to a frame 438 with a non-woven mesh, which itself is supported on one or more fins 440 coming to rest on a base 442. The support post 436 creates room for placement of a purification medium 460 described above. These additional components of the water purification cartridge 400 fit into the cartridge body 444 below the end-of-life apparatus.

The water purification cartridge 400 may be used to purify drinking water, such as in point of use drinking water systems, such as the system illustrated in FIG. 1, or alternatively, in pitchers, and the like.

The cap 401 includes one or more inlet water holes 402. The water entering the cap 401 is unpurified water, whereas the water leaving from the bottom of the cartridge body 444 is purified by passing through one or more purification media 460. Purification media may include one or more of particulate filtration, such as non-woven meshes, activated carbon, such as granulated activated carbon, halogenated media, such as iodinated resins, N-halamines, and the like. Particulate purification media 460 such as granulated activated carbon and/or N-halamines may be placed in the space between the nonwoven meshes 432 and 438.

The end-of-life apparatus, including the carrier 404, tablet 406, plunger 410, spring 420, and the keeper 422 form a unit, which can be attached to the underside of the cap 401.

The carrier 404 includes a flat plate. As best seen in FIG. 17, the underside of the cap 401 includes four posts 450 placed at four respective corners defining a square. The carrier 404 includes corresponding holes 446 to mate with each of the posts 450 on the underside of the cap 401. The flat plate carrier 404 includes two diametrically opposed side recesses 448 that correspond with the placement of the inlet holes 402 in the cap 401. Furthermore, as described below, the recesses 448 allow the plugs 408 to pass by unimpeded to block the holes 402 from the underside of the cap 401. The flat plate carrier 404 includes notches 450 on the remaining two diametrically opposed sides. The notches 450 are for engaging with the keeper 422 as further explained below.

Referring to FIG. 17, the underside of the flat plate carrier 404 includes two cowls 452 placed opposite to one another. Each cowl 452 defines a section of a cylinder. While the cowls are placed opposite to each other, the ends leave two openings 454 created between the ends of the cowls 452. The openings 454 are aligned below the recesses 448 of the carrier 404. The openings 454 allow the plunger 410 to rise up within the openings 454. The diameter described by the opposed cowls 452 is large enough to accommodate a tablet 406 therein. The plunger 410 is placed below the carrier 404.

The plunger 410 includes a supporting structure 416 forming the base of the plunger 410. The supporting structure 416 supports a tablet pedestal 414 in the center thereof. The tablet pedestal 414 is generally a cylinder shape, the height of which can match the height of the cowls 452. Also, the outer diameter of the tablet pedestal 414 is smaller than the inner diameter circumscribed by the inner sides by the opposed cowls 452 on the carrier 404. The plunger supporting structure 416 includes two diametrically opposed appendages extending out from the center of the plunger 410. Each appendage 452 supports a plug pedestal 412 on which a plug 408 sits. The pedestals 412, and therefore, the plugs 408 are in line with the bottom of the inlet holes 402 in the cap 401. Additionally, the pedestals 412, and therefore, the plugs 408 are also aligned to pass by the recesses 448 created in the flat plate carrier 404. The appendages 452 may even fit within the cowl openings 454. The plunger supporting structure 416 includes diametrically opposed guides 418 extending from the center of the plunger support structure 416 at 90 degrees to the position of the appendages 452. Each guide 418 includes a notch into which a rail will fit. The combination of guides 418 with a rail maintains the plunger 410 in straight up and down alignment as the plunger 410 is pushed upward by the force of the spring 420. For this purpose, the underside of the plunger support structure 416 may be constructed to accommodate a helical spring 420. The shape defined by the helical spring 420 may be described as an inverted cone, such that the larger diameter base is oriented upwards against the underside of the plunger 410. The underside of the plunger support structure 416 may have a radiused member to accommodate the spring 420. The individual coils of the spring 420 may fit within each other so as to reduce the height of the spring when fully or nearly fully compressed.

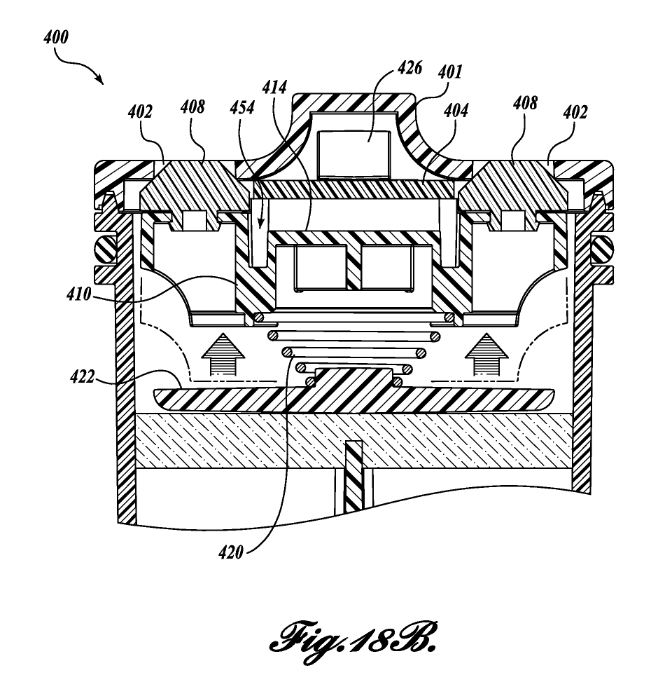

The keeper 422 fits below the plunger and spring and, supports the smaller diameter end of the helical spring 420. The small diameter coil at the bottom of spring 420 may fit on a circular seat 430 which protrudes above the lower surface of the base of the keeper 422. The keeper 422 may generally be described as a flat base having four appendages extending from the center at 90 degrees to one another. Two similar appendages are diametrically opposed to each other, making for two pairs of similar appendages. Two appendages can support a flat post 424 extending perpendicular to the base (i.e., upward in the normal configuration). The flat posts terminate in a barb 426. The inside surface of the flat posts 424 also include rails 428 which fit into the guides 418 of the plunger 410, described above. The barbs 426 engage with the notches 450 of the carrier 404. When assembled, the spring 420 is compressed or preloaded against the keeper 422, the plunger 410 fits above the compressed spring 420 and into the rails 428 of the keeper 422, the tablet 406 rests on the solid upper surface of the pedestal 414, the tablet 406 fits within the cowls 452 and, the barbs 426 are engaged with the notches 450 on the carrier 404, which keeps the keeper 422, spring 420, plunger 410, tablet 406, and carrier 404 as an assembled unit, and further restricts separation of the keeper 422 from the carrier 404. The cap 401 may have a raised center to accommodate the barbs 426, as seen in FIG. 18A. As can be appreciated, as the tablet 406 begins to disintegrate and loses mass and height, the plunger 410 is driven upwards a corresponding amount by the force exerted on it by the spring 420, since the keeper 422 is prevented from separating from the carrier 404.

When assembled into a unit, the carrier 404 is fastened on the underside of the cap 401. The tablet 406, and maybe a portion of the pedestal 414, fit within the cowls 452 such that the appendages 452 are in direct alignment with the openings 454. The height of the pedestal 414 may be the same or smaller than the height of the cowls 452. As the water purification cartridge 400 is put into service, water flows into the cap 401. The water contacts the tablet 406 through at least the openings 454 between cowls 452. Generally, the construction of the cartridge should allow water to flow through and out of the cartridge without impedance that would cause water to fill the cartridge to the level of the tablet 406. Reducing impedance may be achieved by selection of the appropriate characteristics of the mesh 432, including porosity or thickness. The tablet 406 loses mass and height gradually, and the plunger 410 moves upward as a result. Over an extended period of service, the tablet 406 eventually is disintegrated sufficiently such that the plugs 408 reach the bottom of the inlet holes 402. Further disintegration of the tablet 406 only forces the plugs 408 tighter against the inlet holes 402, which will eventually seal around the underside of the inlet holes 402 in the cap 401. The tablet 406 parameters are selected such that the tablet 406 may be designed to disintegrate when a predetermined amount of water has contacted the tablet 406. Parameters of the tablet 406 that may be controlled and varied to arrive at the desired disintegration rate include the hardness of the tablet, the selection of materials for the tablet, increasing or decreasing the size of the cowls 452, and openings 454, for example. In one embodiment, the tablet 406 may be 100% benzoic acid.

Referring to FIGS. 18A and 18B, the operation of the end-of-life apparatus for the water purification cartridge 400 is illustrated. In FIG. 18A, the plunger 410 with the plugs 408 compresses the spring 420 against the base of the keeper 422, when the tablet 406 blocks the ability of the plunger 410 to rise any further. As can be appreciated, the plugs 408 are directly in line below the inlet holes 402. As can also be appreciated, the plugs 408 are aligned to pass by unimpeded by creation of the recesses 448 in the carrier 404. Further, the plugs 408 define a section of cone whose top diameter is smaller than the diameter of the inlet holes 402, however, a diameter in a section of the plug cone 408 is larger than the diameter of the holes 402. Also seen in FIG. 18A is the barb 426 connected to an appendage of the keeper 422. The keeper 422 holds the individual parts as an assembled unit, including the keeper 422, spring 420, plunger 410, tablet 406, and carrier 404. The assembly is also secured to an underside of the cap 401 by placement of the pins 450 engaging with the carrier 404.

Referring to FIG. 18B, the tablet is no longer shown after having been fully disintegrated. However, it is to be appreciated that the plunger 410 may be designed to seal the inlet holes 402 only after the tablet has disintegrated a predetermined amount. The spring 420 has uncoiled partially, driving the plunger 410 upwards such that the plugs 408 seal against the inlet holes 402. The pedestal 414 is shown within the confines of the cowls 454. The barbs 426 prevent the keeper 422 from being separated from the carrier 404, so that instead, the plunger 410 is forced upward.

Tablets used in the various embodiments of the end-of-life devices are described herein. The tablets 136, 236, and 406 may be similar to each other. The description of the tablets below is equally applicable to any one, some or all of the tablets 136, 236, and 406. Tablets may disintegrate or undergo size reduction through dissolution or erosion via the water passing through the end-of-life device and contacting the tablets. A tablet may be a water-soluble tablet or a water-erodible tablet, or a combination. A water-disintegrable tablet means a water-soluble tablet, a water-erodible tablet, or a combination. Tablets 136, 236, and 406 are water-disintegrable tablets.

In some embodiments, the tablets 136, 236, and 406 are water-soluble tablets made from a water-soluble material that is harmless when ingested. A preferred material is benzoic acid. In some embodiments, the tablets 136, 236, and 406 can be 100% benzoic acid which is compatible with the preferred purification media. In some embodiments, the water-soluble tablets 136, 236, and 406 may comprise more than one water-soluble materials.

In some embodiments, the tablets 136, 236, and 406 are water-erodible tablets made from, for example, one or more water-insoluble materials and one or more water-soluble binders. Water-insoluble materials can include poorly water-soluble materials. Water-insoluble or poorly soluble materials include salts of calcium, such as calcium sulfate. Preferably, the water-insoluble material can be inert to, at least, halogen elements, such as bromine, chlorine, fluorine, and iodine. Water-erodible tablets may include a water-soluble material that binds the water-insoluble material. Water-soluble materials may include salts or sugars, including, but not limited to lactose, glucose, lactic acid, potassium acetate, sodium chloride, and the like. Water-erodible tablets may be made by first forming an aqueous slurry containing the water-insoluble material and the water-soluble binder. The slurry may be poured in a mold of desired shape and size and allowed to dry. Because not all the material in the water-erodible tablet dissolves, the mode of action may be dependent more on erosion as compared to dissolution.

Tablets 136, 236, and 406 in either a water-soluble or water-erodible version may further include nutrients, such as vitamins, minerals, zinc, potassium, and the like, or any combination thereof.

Tablets 136, 236, and 406 in either a water-soluble or water-erodible version may further include a phosphate scavenger. Phosphate scavengers can include one or more of iron oxide, ferric oxide hydroxide, zirconium oxide, and the like, or a combination thereof. Phosphate has a tendency to encourage bacteria growth, which can lead to slime in the water. Accordingly, a phosphate scavenger may reduce or deter the occurrence of bacteria and slime.

Tablets 136, 236, and 406 in either a water-soluble or water-erodible version may further include flavorings, natural or artificial, such as citrus, lime, fruit flavors, mint, spearmint, wintergreen, and the like, or any combination thereof.

Tablets 136, 236, and 406 in either a water-soluble or water-erodible version may further include materials that can release halogen elements into the water for the purpose of having residual halogen that can inactivate microorganisms. Halogen-releasing materials can include calcium hypochlorite, dichloroisocyanurate, halogenated hydantoins, such as 1,3-dichloro-5,5-dimethylhydantoin (DCDMH), 1,3-dibromo-5,5-dimethylhydantoin (DBDMH), 1-bromo-3-chloro-5,5-dimethylhydantoin (BCDMH), and the like, or any combination thereof.

Tablets 136, 236, and 406 in either a water-soluble or water-erodible version may further include materials that perform an inactivating function or masking function. For example, some drinking water may be provided with high levels of chlorine. To inactivate the taste and/or smell of chlorine (or other compounds), the inactivating material can be a reducing agent, such as thiosulfate, sodium hydrosulfite, an antioxidant, such as ascorbic acid (vitamin C), or any combination thereof.

Based on the foregoing description, embodiments of water purification cartridges, end-of-life apparatus, and methods are described. However, the following embodiments are not limiting as different embodiments may use one or more of the features described herein in different combinations, while other embodiments may substitute or omit some features.

A water purification cartridge includes a cap having one or more inlet holes; a cartridge body connected to the cap, wherein the cartridge body has one or more outlet holes; and an end-of-life apparatus within the water purification cartridge, wherein the end-of-life apparatus includes: a carrier mounted to the underside of the cap; a keeper connected to the carrier, wherein the carrier and keeper are in a fixed relationship to each other; a compressed spring between the keeper and carrier; and a plunger subjected to a force from the spring, wherein the plunger is in alignment with the inlet holes.

The water purification cartridge may further include a water-disintegrable tablet placed between the plunger and carrier, wherein the tablet prevents the plunger from sealing the one or more inlet holes in the cap.

The water-disintegrable tablet may be a water-soluble tablet, a water-erodible tablet, or a combination.

The water-disintegrable tablet may include at least one of a nutrient, phosphate scavenger, flavoring, halogen-releasing material, reducing agent, and masking agent.

The water purification cartridge may include a keeper having two opposed appendages, each appendage supports a post, each post terminating in a barb that is engaged with the carrier.

The water purification cartridge may include a rail on an inner surface of each post, wherein the rails are engaged with guides on the plunger.

The water purification cartridge may include a plunger comprising two appendages extending outward from a center, and a plug is located on the upper surface of each appendage.

The water purification cartridge may include a plunger comprising a pedestal on a center thereof, wherein a water-disintegrable tablet rests on the pedestal.

The water purification cartridge may include a carrier that includes at least one cowl on the underside thereof, a water-disintegrable tablet is located within the cowl and, an opening is created by the at least one cowl.

An end-of-life apparatus, may include: a carrier comprising a flat plate and at least one cowl on a side of the plate; a keeper connected to the carrier, the keeper comprises a flat base parallel with the carrier, wherein the carrier and keeper are in a fixed relationship to each other; a compressed spring between the keeper and carrier; and a plunger configured to be supported on rails connecting the carrier to the keeper, and the plunger compresses the spring against the keeper.

The end-of-life apparatus may include a water-disintegrable tablet placed between the plunger and carrier.

The water-disintegrable tablet may be a water-soluble tablet, a water-erodible tablet, or a combination.

The water-disintegrable tablet may include at least one of a nutrient, phosphate scavenger, flavoring, halogen-releasing material, reducing agent, or masking agent.

The end-of-life apparatus may include a keeper having two opposed appendages, each appendage supports a post, each post terminating in a barb that is engaged with the carrier.

The end-of-life apparatus may include a rail on an inner surface of each post, wherein the rails are engaged with guides on the plunger.

The end-of-life apparatus may include a plunger comprising two appendages extending outward from a center, and a plug is located on the surface of each appendage facing the carrier.

The end-of-life apparatus may include a plunger comprising a pedestal on a center thereof, wherein a water-disintegrable tablet rests on the pedestal.

The end-of-life apparatus may include a carrier that includes at least one cowl on the underside thereof, a water-disintegrable tablet is located within the cowl and, an opening is created by the at least one cowl.

A method for shutting off water flow to a water purification cartridge after a predetermined volume of water flow, including: providing an end-of-life apparatus in the cartridge, wherein the apparatus comprises a water-disintegrable tablet configured to disintegrate a predetermined amount after contacting the predetermined volume of water flow, wherein the tablet supports a plunger from closing an inlet hole in the cartridge; disintegrating the tablet through contact with water; and closing or substantially closing the inlet hole to the water purification cartridge with the plunger when the tablet disintegrates the predetermined amount.

The method may include forcing the plunger upward against the inlet hole with a compressed spring.

The method may include dissolving the tablet, eroding the tablet, or a combination.

The method may include releasing from the water-disintegrable tablet at least one of a nutrient, phosphate scavenger, flavoring, halogen-releasing material, reducing agent, or masking agent.

A water purification cartridge, includes: a cartridge body connected to a top cover and a bottom base, the cartridge body defining a hollow volume therein with a cross-sectional area; a cup-shaped tray within the hollow volume, wherein a size of a tray area substantially fills the cross-sectional area of the hollow, and the cup-shaped tray is configured to retain a predetermined volume of water; a water-disintegrable tablet between the tray and the base, wherein the tray is prevented from descending by resting on the tablet.

The water purification cartridge may include a shield on the base, the shield comprises a side wall and, the side wall surrounds the tablet.

The shield side wall may have one or more side openings.

The tray may be comprised of a material denser than water.

The water purification cartridge may include a spring pushing against the tray from a top side thereof.

The water-disintegrable tablet may include at least one of a nutrient, phosphate scavenger, flavoring, halogen-releasing material, reducing agent, or masking agent.

The water purification cartridge may include a hollow stand pipe in the tray, wherein the stand pipe height is lower than a rim of the tray, and the height of the stand pipe determines the volume of water retained in the tray.

The water purification cartridge may include at least one inlet hole in the top cap, at least one outlet hole in the base, and the tray underside comprises at least one plug aligned with the at least one hole in the base.

The tray may include one or more guides to guide the tray when descending.

A method for shutting off or substantially shutting off water flow from a water purification cartridge after a predetermined volume of water flow, includes: providing an end-of-life apparatus in the cartridge, wherein the apparatus comprises a water-disintegrable tablet configured to disintegrate a predetermined amount after contacting the predetermined volume of water flow, wherein the tablet supports a cup-shaped tray from closing an outlet in the cartridge; allowing water to flow from an inlet in the top of the cartridge to the cup-shaped tray, wherein a volume of water collects in the cup-shaped tray; allowing water to exit the cup-shaped tray, wherein the tray is weighted down by the volume of water collected in the tray; disintegrating the tablet through contact with water exiting the tray; and closing or substantially closing the outlet from the water purification cartridge with the weighted-down tray when the tablet disintegrates the predetermined amount.

The method may include placing the tablet in a shield on a base of the tray.

The method may include assisting the tray to close the outlet by placing a compressed spring to push on the tray.

The method may include releasing from the water-disintegrable tablet at least one of a nutrient, phosphate scavenger, flavoring, halogen-releasing material, reducing agent, or masking agent.

While illustrative embodiments have been illustrated and described, it will be appreciated that various changes can be made therein without departing from the spirit and scope of the invention.

The embodiments of the invention in which an exclusive property or privilege is claimed are defined as follows:

1. A water purification cartridge, comprising:
a cap having one or more inlet holes;
a cartridge body connected to the cap, wherein the cartridge body has one or more outlet holes; and
an end-of-life apparatus within the water purification cartridge, wherein the end-of-life apparatus comprises:
a carrier mounted to the underside of the cap;
a keeper connected to the carrier, wherein the carrier and keeper are in a fixed relationship to each other;
a compressed spring between the keeper and carrier; and
a plunger subjected to a force from the spring, wherein the plunger is in alignment with the inlet holes.

2. The water purification cartridge of claim 1, further comprising a water-disintegrable tablet placed between the plunger and carrier, wherein the tablet prevents the plunger from sealing the one or more inlet holes in the cap.

3. The water purification cartridge of claim 2, wherein the water-disintegrable tablet is a water-soluble tablet, a water-erodible tablet, or a combination.

4. The water purification cartridge of claim 3, wherein the water-disintegrable tablet further comprises at least one of a nutrient, phosphate scavenger, flavoring, halogen-releasing material, reducing agent, and masking agent.

5. The water purification cartridge of claim 1, further comprising a keeper having two opposed appendages, each appendage supports a post, each post terminating in a barb that is engaged with the carrier.

6. The water purification cartridge of claim 3, further comprising a rail on an inner surface of each post, wherein the rails are engaged with guides on the plunger.

7. The water purification cartridge of claim 1, further comprising a plunger comprising two appendages extending outward from a center, and a plug is located on the upper surface of each appendage.

8. The water purification cartridge of claim 1, further comprising a plunger comprising a pedestal on a center thereof, wherein a water-disintegrable tablet rests on the pedestal.

9. The water purification cartridge of claim 1, further comprising a carrier that includes at least one cowl on the underside thereof, a water-disintegrable tablet is located within the cowl and, an opening is created by the at least one cowl.

10. An end-of-life apparatus, comprising:
a carrier comprising a flat plate and at least one cowl on a side of the plate;
a keeper connected to the carrier, the keeper comprises a flat base parallel with the carrier, wherein the carrier and keeper are in a fixed relationship to each other;
a compressed spring between the keeper and carrier; and
a plunger configured to be supported on rails connecting the carrier to the keeper, and the plunger compresses the spring against the keeper.

11. The end-of-life apparatus of claim 10, further comprising a water-disintegrable tablet placed between the plunger and carrier.

12. The end-of-life apparatus of claim 11, wherein the water-disintegrable tablet is a water-soluble tablet, a water-erodible tablet, or a combination.

13. The end-of-life apparatus of claim 12, wherein the water-disintegrable tablet further comprises at least one of a nutrient, phosphate scavenger, flavoring, halogen-releasing material, reducing agent, or masking agent.

14. The end-of-life apparatus of claim 10, further comprising a keeper having two opposed appendages, each appendage supports a post, each post terminating in a barb that is engaged with the carrier.

15. The end-of-life apparatus of claim 10, further comprising a rail on an inner surface of each post, wherein the rails are engaged with guides on the plunger.

16. The end-of-life apparatus of claim 10, further comprising a plunger comprising two appendages extending outward from a center, and a plug is located on the surface of each appendage facing the carrier.

17. The end-of-life apparatus of claim 10, further comprising a plunger comprising a pedestal on a center thereof, wherein a water-disintegrable tablet rests on the pedestal.

18. The end-of-life apparatus of claim 10, further comprising a carrier that includes at least one cowl on the underside thereof, a water-disintegrable tablet is located within the cowl and, an opening is created by the at least one cowl.

19. A method for shutting off water flow to a water purification cartridge after a predetermined volume of water flow, comprising:
providing an end-of-life apparatus in the cartridge, wherein the apparatus comprises a water-disintegrable tablet configured to disintegrate a predetermined amount after contacting the predetermined volume of water flow, wherein the tablet supports a plunger from closing an inlet hole in the cartridge;
disintegrating the tablet through contact with water; and
closing or substantially closing the inlet hole to the water purification cartridge with the plunger when the tablet disintegrates the predetermined amount.

20. The method of claim 19, further comprising forcing the plunger upward against the inlet hole with a compressed spring.

21. The method of claim 19, wherein disintegrating the tablet includes dissolving the tablet, eroding the tablet, or a combination.

22. The method of claim 19, further comprising releasing from the water-disintegrable tablet at least one of a nutrient, phosphate scavenger, flavoring, halogen-releasing material, reducing agent, or masking agent.

23. A water purification cartridge, comprising:
a cartridge body connected to a top cover and a bottom base, the cartridge body defining a hollow volume therein with a cross-sectional area;
a cup-shaped tray within the hollow volume, wherein a size of a tray area substantially fills the cross-sectional area of the hollow, and the cup-shaped tray is configured to retain a predetermined volume of water;
a water-disintegrable tablet between the tray and the base, wherein the tray is prevented from descending by resting on the tablet.

24. The water purification cartridge of claim 23, further comprising a shield on the base, the shield comprises a side wall and, the side wall surrounds the tablet.

25. The water purification cartridge of claim 24, wherein the side wall has one or more side openings.

26. The water purification cartridge of claim 23, wherein the tray is comprised of a material denser than water.

27. The water purification cartridge of claim 23, further comprising a spring pushing against the tray from a top side thereof.

28. The water purification cartridge of claim 23, wherein the water-disintegrable tablet further comprises at least one of a nutrient, phosphate scavenger, flavoring, halogen-releasing material, reducing agent, or masking agent.

29. The water purification cartridge of claim 23, comprising a hollow stand pipe in the tray, wherein the stand pipe height is lower than a rim of the tray, and the height of the stand pipe determines the volume of water retained in the tray.

30. The water purification cartridge of claim 23, comprising at least one inlet hole in the top cap, at least one outlet hole in the base, and the tray underside comprises at least one plug aligned with the at least one hole in the base.

31. The water purification cartridge of claim 23, wherein the tray comprises one or more guides to guide the tray when descending.

32. A method for shutting off water flow from a water purification cartridge after a predetermined volume of water flow, comprising:
providing an end-of-life apparatus in the cartridge, wherein the apparatus comprises a water-disintegrable tablet configured to disintegrate a predetermined amount after contacting the predetermined volume of water flow, wherein the tablet supports a cup-shaped tray from closing an outlet in the cartridge;
allowing water to flow from an inlet in the top of the cartridge to the cup-shaped tray, wherein a volume of water collects in the cup-shaped tray;
allowing water to exit the cup-shaped tray, wherein the tray is weighted down by the volume of water collected in the tray;
disintegrating the tablet through contact with water exiting the tray; and
closing or substantially closing the outlet from the water purification cartridge with the weighted-down tray when the tablet disintegrates the predetermined amount.

33. The method of claim 32, further comprising placing the tablet in a shield on a base of the tray.

34. The method of claim 32, further comprising assisting the tray to close the outlet by placing a compressed spring to push on the tray.

35. The method of claim 32, further comprising releasing from the water-disintegrable tablet at least one of a nutrient, phosphate scavenger, flavoring, halogen-releasing material, reducing agent, or masking agent.
